(19) United States
(12) Patent Application Publication
(10) Pub. No.: US 2022/0322674 A1
(43) Pub. Date: Oct. 13, 2022

(54) ALGINATE SLUDGE COMPOSITION COMPRISING NON-PATHOGENIC BACTERIA AND HYDROPHILIC AND LIPOPHILIC SUBSTANCES FOR AGRICULTURAL USE

(71) Applicant: GRACE BREEDING LTD., Kfar Saba (IL)

(72) Inventors: Mor ZEILKHA, Ramat Gan (IL); Amit AVIDOV, Kiryat Tivon (IL); Avner BARAZANI, Omer (IL)

(21) Appl. No.: 17/641,612

(22) PCT Filed: Sep. 10, 2020
(86) PCT No.: PCT/IL2020/050998

§ 371 Date: Mar. 9, 2022

Related U.S. Application Data
(60) Provisional application No. 62/898,211, filed on Sep. 10, 2019.

(51) Int. Cl. A01N 59/00; A01N 63/22; A01N 25/04; A01N 25/28; C05G 5/40; C05C 9/00; C05G 5/35; A01N 25/10

(52) U.S. Cl. CPC A01N 59/00; A01N 63/22; A01N 25/04; A01N 25/28; C05G 5/40; C05C 9/00; C05G 5/35; A01N 25/10

(57) ABSTRACT

The present invention is directed to a process for the preparation of liquid or sludge slow-release compositions suitable for agricultural use, comprising one or more active ingredients selected from the group consisting of fertilizers, pesticides, lipophilic and/or hydrophilic compounds, and mixtures of non-pathogenic bacteria together with lipophilic and/or hydrophilic compounds, wherein these actives become encapsulated in an alginate matrix. The direction also encompasses compositions prepared by this process and methods for using said compositions for the delivery and slow release of agrochemicals and other actives in close proximity to the roots of plants.

### FIELD OF THE INVENTION

The present invention relates to encapsulated controlled-release compositions comprising one or more active ingredients intended for agricultural use. More specifically, the invention provides compositions encapsulated in an alginate matrix, as a means for providing improved stability and slow release delivery within the context of agricultural use.

### BACKGROUND OF THE INVENTION

The use of encapsulation as a means for formulating lipidic substances is well known in the art.

U.S. Pat. No. 4,389,419, for example, relates to a process for encapsulating oils and oil-soluble substances in microcapsules. The first steps of this prior art process is the formation of an emulsion having a continuous phase, which is an aqueous solution of an alkali metal alginate, and a dispersed phase of a lipid substance. The emulsion is then formed into droplets which are thereafter immersed in an alcoholic solution of multivalent cations, to produce a shape-retaining alginate matrix filled with precipitated polysaccharide and enclosing plural oil droplets. In this way, the vitamins are protected from oxidative degradation.

Alginates are polysaccharides obtained from brown algae, which have become important hydrocolloids for use in many different de industrial applications.

Alginate is a polysaccharide that contains β-(1→4)-D-mannuronic acid of the following structure:

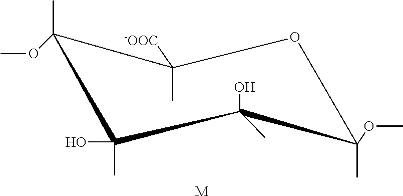

and α-(1→4)-L-guluronic acid of the following structure:

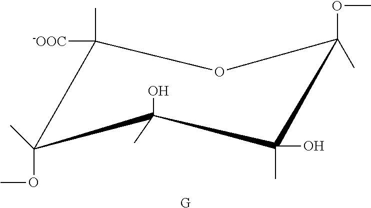

Alginate is a heterogeneous polymer containing three different types of molecular block:
a) M-block, consisting of only M-M linking
b) G-block, consisting of only G-G linking; and
c) Random block, M and G randomly linked.

Calcium alginate gel beads have been used in various settings in order to entrap a wide variety of substances. This approach is particularly advantageous, because of the mild conditions employed and the nontoxicity of the reactants. Typically, the procedure involves dropping a 1-2% solution of sodium alginate into a 1-2% solution of a calcium source, such as calcium chloride. This may be achieved by means of forcing the alginate solution through a small aperture, such as a needle, or rotating plate or droplet feeder and allowed to free-fall, thereby producing a spherical bead, which gels upon contact with the calcium source. The beads then remain in contact with the calcium ions until hardened.

U.S. Pat. No. 6,146,671 discloses a method for protecting a heat and/or oxygen-labile compound by means of encapsulation in a protective matrix comprising alginate and an additional polymeric material, thereby providing a single layer coating system.

WO2018/051344 discloses compositions comprising non-pathogenic bacteria together with various plant-derived lipophilic and hydrophilic activating agent, for use in protecting plant and animal hosts against fungal, bacterial and viral diseases.

WO2019/142199 discloses compositions comprising a mixture of nitrogen-fixating bacteria, together with additional plant-based agents, for use in inducing nitrogen fixation in plants, particular in those species which are normally unable to obtain their nitrogen requirements by means of the fixation of atmospheric nitrogen.

Both of the international patent application publications mentioned immediately hereinabove disclose and claim compositions which have high efficacy and no toxicity for the plants treated therewith. However, their administration by conventional means (e.g. by providing the compositions formulated as Perlite granules, which are then added to the furrows), is sometimes associated with some drawbacks, such as the need for relatively large amounts of the protective or nitrogen-fixing compositions, and/or sub-optimal stability.

The present invention provides a novel alginate-based system which may be used to overcome these drawbacks of the prior art preparations, and provide improved stability, bioavailability and controlled delivery of compositions comprising plant-protective agents, pesticides and/or fertilizers to growing plants in a non-solid form.

### SUMMARY OF THE INVENTION

It has now been unexpectedly found by the present inventors that it is possible to produce non-dry compositions (e.g. in the form of a sludge, slurry or liquid) suitable for administration to growing plants, comprising active ingredients which are encapsulated within an alginate matrix. The use of such non-dry compositions permits the delivery and controlled-release of actives in very close proximity to the roots and other important tissues of growing plants.

In one aspect, the present invention is directed to a process for the preparation of a composition that is suitable for agricultural use, wherein said composition comprises one or more active ingredients selected from the group consisting of fertilizers, pesticides, lipophilic and/or hydrophilic compounds and mixtures of non-pathogenic bacteria together with lipophilic and/or hydrophilic compounds, said process comprising the steps of:
(a) Preparing a solution of an alkali metal alginate;
(b) Preparing a solution, suspension or emulsion of one or more said active ingredients.
(c) Optionally reducing the particle size of said one or more active ingredients in the solution, suspension or emulsion obtained in step (b), in the presence of a surface-active agent, wherein the final average particle size is 300 μm or less.
(d) Mixing the solution obtained in step (a) with the solution, suspension or emulsion obtained in either step (b) or step (c) and packaging the resulting mixture.
(e) With intensive mixing, add a solution containing calcium ions to the product of step (d), thereby obtaining a sludge comprising said one or more active ingredients encapsulated in alginate particles.

In one embodiment, the solution of the alkali metal alginate is an aqueous solution. In one embodiment, the concentration of said alginate is in the range of 0.2-1% (w/v).

In some embodiments, the composition is a controlled-release composition (with respect to the release of the active ingredient(s) from the alginate encapsulation). In one preferred embodiment, the controlled-release composition is a slow-release composition. In most embodiments, the composition is an aqueous or water-based composition.

In one embodiment of this aspect of the invention, the active ingredient is a fertilizer. Although any substance having fertilizing properties of either natural or synthetic origin may be used in this embodiment, examples of suitable fertilizers, such as, but not limited to water soluble or dispersible fertilizers, such as potassium chloride, urea, monocalcium phosphate, micro elements or iron, wherein said fertilizers are suitable for administration through irrigation systems. In this embodiment, the source of calcium ions used in the process is preferably calcium nitrate, calcium acetate, calcium magnesium acetate. Alternatively, another calcium salt, such as calcium chloride, or a non-calcium source of divalent metallic ions, such as magnesium acetate, may also be used.

In another embodiment, the active ingredient is a pesticide Any type of pesticide (insecticide, herbicide, fungicide, bactericide, viricide etc.) may be used in this process. One non-limiting example is the triazole fungicide flutriafol.

In one aspect, the present invention provides a process for the preparation of a composition for agricultural or horticultural use, wherein said composition comprises an emulsion of lipophilic and hydrophilic compounds together with one more species of non-pathogenic bacteria, said process comprising the steps of:
(a) Preparing a solution of an alkali metal alginate at a concentration 0.2%-1%.
(b) Particle size reduction of a mixture of lipophilic and hydrophilic compounds in the presence of a surface-active agent to below 300 μM.
(c) Mixing the solution obtained from step (a) with the reduced particle-size emulsion obtained from step (b), and packaging said mixture.
(d) To the product obtained in step (c), add non-pathogenic bacteria, mix together.
(e) With intensive mixing, add a solution containing Ca²⁺ to the product of step (d), thereby obtaining an alginate sludge.
(f) Continuing the intensive mixing to create a homogeneous alginate sludge mixture.

Generally, in the embodiment disclosed immediately above, step (d) (addition of non-pathogenic bacteria) is carried out by the end-user, immediately (or at most a half-hour) before use.

In one preferred embodiment of the process of the invention, the non-pathogenic bacteria added in step (e) are Rhizobium species (used when the composition is intended to encourage nitrogen fixation in the target plant species). In another preferred embodiment of this aspect of the invention, the non-pathogenic bacteria are Azospirillum species.

In another preferred embodiment, the non-pathogenic bacteria added in step (e) are Bacillus species, for example B. subtilis (used when the composition is intended to protect the target plant species against infection or infestation with bacteria, fungi or viruses).

In another aspect, the present invention provides a process for the preparation of a composition suitable for agricultural use, wherein said composition comprises an emulsion of lipophilic and hydrophilic compounds, said process comprising the steps of:
(a) Preparing a solution of an alkali metal alginate at a concentration 0.2%-1%.
(b) Optional particle size reduction of a mixture of lipophilic and hydrophilic compounds in the presence of a surface-active agent to below 300 μM.
(c) Mixing the solution obtained from step (a) with the reduced particle-size emulsion obtained from step (b), and packaging said mixture.
(d) With intensive mixing, add a solution containing Ca²⁺ to the product of step (c), thereby obtaining an alginate sludge.
(e) Continuing the intensive mixing to create a homogeneous alginate sludge mixture.

In one embodiment of the process described immediately above, the composition further comprises one or more agrochemicals such as pesticides, fertilizers, and so on.

In one embodiment the source of calcium ions used in the process is calcium chloride, monocalcium phosphate (MCP), calcium nitrate (Ca(NO₃)₂, calcium acetate, magnesium acetate or calcium magnesium acetate (CMA).

In one embodiment, the alkali metal alginate used in the processes of the present invention is sodium alginate. In another embodiment, the alkali metal alginate is potassium alginate.

In one embodiment the surface-active agent used in step (b) of the process is a non-ionic surfactant (e.g. sucrose palmitate or similar).

In one embodiment, the mixture of lipophilic and hydrophilic compounds used in step (b) of the process comprise one or more substances having anti-inflammatory activity. Preferably, said compounds are compounds of natural origin, such as plant extracts. Examples of such compounds are disclosed in co-owned international patent application publications WO2018/051344 and WO2019/142199, both of which are incorporated herein by reference in their entirety.

In another embodiment, the mixture of lipophilic and hydrophilic compounds used in step (b) of the process may comprise one or more agrochemical agents, such as commercially available fertilizers or pesticides.

In another aspect, the present invention provides a composition suitable for agricultural use, comprising one or more active ingredients enveloped by a surfactant and encapsulated in an alginate matrix, wherein said one or more active ingredients are selected from the group consisting of fertilizers, pesticides, lipophilic and/or hydrophilic compounds, and mixtures of non-pathogenic bacteria together with lipophilic and/or hydrophilic compounds, and wherein said composition has a non-dry physical form selected from the group consisting of a sludge, slurry or liquid.

In one preferred embodiment, the active ingredient in the composition of the present invention comprises one or more fertilizers. Any suitable fertilizer may be used in this aspect of the invention, but in one preferred embodiment, the composition comprises urea.

In another preferred embodiment, the active ingredient in the composition of the present invention comprises one or more pesticides, including, but not limited, to those disclosed hereinabove.

In another preferred embodiment, the active ingredients in the composition of the present invention comprise a mixture of lipophilic and/or hydrophilic compounds in the form of an oil in water emulsion. In one preferred version of this aspect of the invention, the lipophilic and/or hydrophilic compounds are compounds with anti-inflammatory activity. In one preferred embodiment, this mixture of compounds are those disclosed in Example 1 of co-owned WO 2018/051344, and described briefly in present Example 7, hereinbelow.

In another preferred embodiment, the active ingredients in the composition of the present invention comprise a mixture of lipophilic and/or hydrophilic compounds in the form of an oil in water emulsion, wherein said mixture is itself mixed with one or more species of non-pathogenic bacteria. This latter term is to be understood as referring to bacterial species that do not generally cause disease in plants of horticultural or agricultural importance. In one preferred embodiment of this aspect, the non-pathogenic bacterial species are nitrogen-fixing bacteria, more preferably selected from the group consisting of Rhizobium species and Azospirillum species. In another preferred embodiment of this aspect, the non-pathogenic bacterial are of the species Bacillus subtilis.

In another aspect, the present invention is directed to a method for the slow-release administration of one or more water-miscible active ingredients to the roots and/or other tissues of growing plants, comprising the steps of:

a) providing a composition comprising said one or more active ingredients enveloped by a surfactant and encapsulated in an alginate matrix, wherein said composition has a non-dry physical form selected from the group consisting of a sludge, slurry or liquid.

b) delivering said composition to said growing plants by depositing said composition in a non-dry form in close proximity to the roots and/or other tissues of said plants,
wherein said one or more active ingredients are selected from the group consisting of fertilizers, pesticides, lipophilic and/or hydrophilic compounds, and mixtures of non-pathogenic bacteria together with lipophilic and/or hydrophilic compounds.

In one preferred embodiment of this aspect of the present invention, the composition is delivered to the plant by means of drip irrigation, other means of irrigation that brings water and/or administered compositions into close proximity with the root system of growing plants. In another preferred embodiment, the composition is delivered to the plant by means of direct injection into the roots and/or other tissues of said plant (e.g. into, or underneath, the bark of a tree).

The present invention further provides a method for supplying the nitrogen requirements of a plant comprising administering to said plant a combination of non-pathogenic, atmospheric nitrogen-fixing bacteria and a mixture of one or more lipophilic and hydrophilic activating agents, wherein said bacteria and activating agents are enveloped by a surfactant and encapsulated in an alginate matrix, wherein said composition has a non-dry physical form selected from the group consisting of a sludge, slurry or liquid; and

b) delivering said composition to said growing plants by depositing said composition in a non-dry form in close proximity to the roots and/or other tissues of said plants.

In one preferred embodiment, the non-pathogenic atmospheric nitrogen-fixing bacteria are members of the Rhizobium genus, more preferably, Rhizobium leguminosarum. In another preferred embodiment, said nitrogen-fixing bacteria ae members of the Azospirillum genus, for example Azospirillum brasilense or Azospirillum canadense.

The present invention also provides a method for increasing the ability of a plant species to resist damage caused by fungal, bacterial and/or viral pathogens, wherein said method comprises administering to said plant species a combination of non-pathogenic bacteria and a mixture of one or more lipophilic and hydrophilic activating agents, wherein said bacteria and activating agents are enveloped by a surfactant and encapsulated in an alginate matrix, wherein said encapsulated mixture has a non-dry physical form e.g. a liquid, slurry or sludge, and wherein said mixture is administered in a non-dry form in close proximity to the roots and/or other tissues of said plant species by any suitable means for liquid delivery, including, but not limited to drip irrigation and direct injection into the plant tissues (e.g. under the bark of a tree).

In one preferred embodiment of this aspect of the invention, the non-pathogenic bacterial are of the Bacillus genus, most preferably of the species Bacillus subtilis.

With regard to both of the plant-treatment methods defined immediately hereinabove, in one embodiment, the alginate matrix comprising the active ingredients is in the form of a wet sludge.

In these methods, the one or more activating agents are preferably substances having anti-inflammatory activity.

In both of these methods, the alginate matrix compositions may be administered by injecting them below the growing seedling, to the growing plant, into a tree trunk, or by drip irrigation techniques that are well known to the skilled artisan in the field.

More details concerning these methods may be found in two co-owned international patent applications, published as WO2018/051344 and WO2019/142199, both of which are incorporated herein by reference.

### DETAILED DESCRIPTION OF THE INVENTION

The following description is illustrative of embodiments of the invention. The following description is not to be construed as limiting, it being understood that the skilled person may carry out many variations to the invention.

As disclosed hereinabove, the present invention provides a composition comprising one or more lipophilic and hydrophilic compounds and non-pathogenic bacteria, enveloped by a surfactant, encapsulated in an alginate matrix.

This particular chemical and physical form of the composition possesses a number of highly significant advantages in relation to other dosage forms currently in agricultural use.

One of the key advantages of the present invention relates to the fact that the encapsulation within an alginate matrix causes the retention of the physically close relationship between the bacteria and the emulsion. Thus, as explained hereinabove, in the final stages of the process for preparing the composition of the present invention, there is a need for intensive mixing of the liquid composition to create a homogeneous alginate sludge mixture. One of the reasons for this requirement is to ensure that the bacteria and the activating agent emulsion become intimately associated, in order that the two fractions may interact with each other. However, this spatial arrangement may be easily lost if the final physical form of the composition does not preserve said arrangement. The alginate matrix of the present invention, however, does maintain this spatial arrangement thereby leading to significant improvements in both efficacy and potency of the composition, in comparison with prior art compositions.

Furthermore, in the present invention, the bacteria and the activating agent emulsion are mixed immediately prior to use. The bacteria are maintained in liquid suspension, and are therefore more stable (as opposed, for example, to the loss of active cells as a consequence of drying the composition, as in prior art methods). The higher percentage of live, active bacteria in the composition of the present invention thus contributes to the potency of said composition, thereby permitting the use of smaller volumes thereof.

Another advantage of the composition of the present invention (particularly in the cases in which the alginate sludge is used wet rather than dried), the bacteria are preserved alive and active throughout the process of preparing the composition. Thus, upon application or administration of the composition to the target plant species, the bacteria are immediately available in their life, active form—as opposed to the need to ‘revive’ the bacteria with water as in the case, for examples, of pellet compositions based on the use of Perlite. Thus, the present invention is characterized by the absence of a lag phase (with respect to bacterial integrity). Similarly, when using pellet systems based on Perlite or similar substrates, there is a need to dry the Perlite, a process which is associated with an increase in the percentage of dead bacteria.

A further very important feature of the present invention relates to the fact that there is no danger of bacterial contamination of the composition (i.e. contamination with other non-desirable species of bacteria). Usually, when using a system based on alginate (or any similar system with a water activity greater than 15%), there may be a problem with undesired bacterial growth, and to prevent this, it would be necessary to dry the alginate (and thereby lose all of the aforementioned advantages). However, the present invention overcomes this problem by means of using a two-stage process, wherein the first stage is the preparation of separate activating agent and bacterial aliquots, and only mixing the two immediately before administering the composition to the plant. This arrangement therefore ensures that only the desired, non-pathogenic bacterial strain is added, and not an additional undesired contaminant species.

A yet further advantage of the composition of the present invention is the fact that the physical form of the composition of the present invention (i.e. a sludge) permits much closer contact of the active ingredients with the plant roots, stems or tree-trunks than prior art forms. This is able to occur because the deliver, y system used (drip irrigation or direct injection) ensures this very close proximity, in contradistinction to dried material which is generally scattered in the general vicinity of the target plants, thus leading to greater losses. This close contact is particularly advantageous, since it allows the active ingredients which are released from the alginate sludge to stay very close to the root system of the plants, thereby preventing the material from being dispersed away from said plants, as seen with dry granular formulations. Thus, the physical form of the composition of the present invention (i.e. liquid or sludge) directly contributes to the aforesaid advantageous features.

A still further advantage of the liquid/sludge form of the composition of the present invention is that the fact that it may be easily delivered through a regular drip irrigation system means that it is much easier to control the timing of the dose administration. Thus, this temporal advantage, when combined with the spatial advantage mentioned above (i.e. the precision regarding the location of delivery), and with the possibility to select different alginate/calcium salt formulations having different release profiles, results in an agricultural delivery system which is much more controllable than any of the prior art alternatives.

A further advantage of the composition of the present invention relates to the fact that the alginate matrix provides for both additional stability of the active components, as well as for controlled delivery, such as slow release, of said components into the tissues of the treated plants.

Finally, it is to be noted that the present alginate-based system is significantly cheaper to prepare and use than prior art Perlite compositions. Similarly, when compared in terms of activity, much smaller volumes of the present composition are required than in the case of Perlite-based compositions, thereby assisting to reduce transportation costs.

Throughout the description, percentages of components are by weight, unless specifically noted differently. The term “particle size” also refers to the size drops of liquid emulsion.

It has surprisingly been found by the present inventions that the use of lipophilic and hydrophilic compounds which have been treated with a surfactant and mixed with bacteria, said mixture being encapsulated in an undried alginate matrix, provides a stable sludge composition with a controlled released of the mixture in a soil medium.

The release pattern of the active components of the composition (i.e. the admixture of the non-pathogenic bacteria and the lipophilic and hydrophilic activating agents together with the non-pathogenic bacteria) is related to the concentration of alginate present in the sludge and/or or to the viscosity of the alginate (as measured in a 1% solution at 25 C).

Thus, increasing the alginate concentration and/or viscosity can slow the release of the active components. In this way, it is possible to adjust the product to suit different climatic conditions

The lipophilic and hydrophilic compounds which are sensitive to oxygenating and high water rainfall or high irrigation conditions enjoy a degree of protection by virtue of their incorporation into the alginate sludge matrix, thereby improving the chemical and physical stability of the compositions of the present invention.

As explained above, the process of the present invention may be used to prepare compositions comprising mixtures of hydrophobic and/or hydrophilic activating agents with non-pathogenic bacteria. Such compositions are generally prepared (as disclosed above) as two separate units, with the user mixing said bacteria with the already-encapsulated activating agents immediately before use.

As disclosed hereinabove, the process of the present invention may be used to prepare alginate sludge formulations containing active ingredients such as urea or other water-soluble fertilizers or microelements or pesticides. Such formulations may be used alone, or alternatively, may also incorporate the mixtures of non-pathogenic bacteria and activating agents already described above, thereby constituting a complete plant-care system.

The slow release profile of the compositions of the present invention is important for maintaining optimal concentrations of the active ingredients over a long time period. In addition, the alginate-encapsulated nature of the composition is instrumental in maintaining close contact between the various combinations of actives, when present.

Furthermore, the use of a water-soluble sludge which may be delivered to the growing plants by means of injection or drip irrigation results in the maintenance of the actives close to the plant roots, thereby simultaneously minimizing the underground water contamination with active agents, some of which are known to be toxic and can lead to serious environmental contamination problems. In some cases, this also significantly reduces the amount of the active ingredients that need to be delivered to the growing plants. Thus, for example, urea may be used at much lower amounts than when delivered in other physical forms, such as granules. Furthermore, in certain embodiments of the present invention, a very low dosage of urea (e.g. 1/10 of the usual amount for granule formulations) may be combined with nitrogen fixing bacteria (such as Rhizobium or Azospirillum species), such that said urea supplies the plant's nitrogen requirements at a very early stage, before the activation of the nitrogen-fixing bacteria has started.

Clearly, the reduction in the amount of active ingredients that need to be incorporated into the liquid or sludge formulations of the present invention is advantageous not only with regard to a reduction in the amount of potential environmental contamination (due to run-off from poorly-localized granule formulations), but also with regard to savings in plant maintenance costs.

Controlling the Release Pattern of the Active Ingredients:

A further advantage of the alginate sludge formulations of the present invention is that it is possible to predetermine or control the release rate of the actives from their encapsulated state.

Thus, the release pattern can be altered by means of changing the concentration of alginate, the type of calcium salt, the concentration of the calcium salt, and/or the type of alginate, as defined by its viscosity at 1% in water at 25° C. For example, high concentrations of calcium salts, and independently, high concentrations of the alginate in the formulate can lead to slower release of the actives (see Example 8, hereinbelow).

With regard to the type of calcium salt used, when used at the same concentration, different salts, such as CaCl₂, MCP, Ca(NO₃)₂ and calcium magnesium acetate (CaMgAC), the release pattern differs for each of said sorts, with the fastest release profile being seen with the acetate salt.

Higher alginate viscosity at the same concentration of alginate and salt can increase releasing pattern.

It is to be noted that the term ‘sludge’, which is used herein to describe the physical form of the composition of the present invention, is to be understood as referring to a viscous fluid—as opposed to either the thin, watery consistency of a simple aqueous solution or to any of the solid forms of composition well known to the skilled artisan. The ‘sludge’ consistency of the composition may also be considered to have the same or similar properties to a slurry. The composition of the present invention is not limited to a sludge or slurry of any particular viscosity, and indeed the ability to alter the controlled release properties of the composition by means of altering its viscosity is part of the present invention, as explained hereinabove.

It is also to be noted that the term ‘agricultural’ as used herein, is to be understood to refer to any situation where plants are grown, including commercial farming (i.e. agriculture in the usual sense), but also to horticultural and other possibly non-commercial gardening activities.

Some of the advantages of the present invention will now be demonstrated in the following non-limiting examples.

### EXAMPLES

### Example 1

### Preparation of a Composition of the Present Invention, Suitable for Use in a Method for Preventing or Treating Bacterial, Fungal or Viral Infections in Plants

In the first step the following ingredients were obtained:

(a)

| | |
|---|---|
| 1. Alginate SATIALGINE S 60 NS - | 1 g. |
| 2. low calcium water | 200 g |

The two solution were mixed together to form a homogenous suspension

| | |
|---|---|
| 3. An emulsion containing a mixture of hydrophilic | 10 g |
| and lipophilic activating agents (prepared as | |
| described hereinbelow in Example 3) | |

This emulsion was added to the mixture of items 1 and 2, above.

The resulting liquid is then packaged (e.g. in a plastic bag), and sealed, in order to prevent any microbial contamination.

| | |
|---|---|
| (b) Add Rhizobium bacteria (Bio - Lab 960101) | 6 g |

Prior to use in the field, the two solutions are mixed together to form a homogenous suspension

(c) To the mixture obtained at the end of step (b), add Ca(NO₃)₂ 1.1 g dissolved in 15 g water.

This final mixture is then subjected to high sheer mixing for 20 minutes, prior to application to the plants.

### Example 2

### Preparation of a Composition of the Present Invention, Suitable for Use in a Method for Causing or Increasing Nitrogen Fixation in Plants

In the first step the following ingredients were taken:

(a)

| | |
|---|---|
| 1. Alginate SATIALGINE S 60 NS - | 0.6 g. |
| 2. Low calcium water | 200 g |

The two solution were mixed together to form a homogenous suspension

| | |
|---|---|
| 3. Add activating agent emulsion | 10 g |
| as described in Example 3 - | |

The product of this stage is packaged in order to prevent microbial contamination.

(b)

| | |
|---|---|
| 1. Add ‘Serenade’ solution containing strain | 7 g |

QST 713 of Bacillus subtilis (obtained from Bayer)

The two solutions were mixed together to form a homogenous suspension

(c)

| | |
|---|---|
| 1. To the product of step (b), add CaCl₂ 35% | 3.5 g |

This final mixture is then subjected to high sheer mixing for 20 minutes, prior to application to the plants.

### Example 3

Activating agent emulsion for use in a composition of the present invention

| | | |
|---|---|---|
| Oil phase | Sclareol | 16.00 g |
| Oil Phase | Lecithin | 50.00 g |
| Oil phase | MCT | 80.00 g |
| Oil phase | Total oil phase: | 146.00 g |

| | | |
|---|---|---|
| Water phase | Ester of sugar and fatty | 22.00 g |
| | acid | |
| Water phase | Naringin | 16.00 g |
| Water phase | Water | 200.00 g |
| Water phase | Glycerol | 616.00 g |

The oil phase is added slowly to the water phase, yielding an emulsion with a total volume of 1,000 ml.

### Example 4

### Slow Release Urea for Irrigation Purposes

| | |
|---|---|
| 1. Alginate SATIALGINE S 60 NS - - | 0.6 g. |
| 2. Low calcium water - | 200 g |

Extensive mixing for 20 min extensive until all of the sodium alginate is completely dissolved.

| | |
|---|---|
| 3. Urea | 15 g |

Add to the solution obtained in the previous step and mix to completely dissolve the Urea.

4. Add 0.5% Ca salt as Ca(NO₃)₂ dissolved in 10 ml water.

This final mixture is then subjected to high sheer mixing for 20 minutes, prior to application to the plants.

### Example 5

### Slow Release KCL for Irrigation Purposes

| | |
|---|---|
| 1. Alginate SATIALGINE S 60 NS | 0.6 g. |
| 2. Low calcium water | 200 g |

Extensive mixing for 20 minutes until all the sodium alginate is completely dissolved.

| | |
|---|---|
| 3. KCL potassium chloride | 25 g |

Mix the solution until completely dissolved.

4. Add 0.5% Ca salt as CaMgAc (CMA—calcium magnesium acetate) from VIPER2.0 ice melt grade dissolved in 10 ml water.

This final mixture is then subjected to high sheer mixing for 20 minutes, prior to application to the plants.

### Example 6

### Slow Release Pesticide for Irrigation Purposes

| | |
|---|---|
| 1. Alginate SATIALGINE S 60 NS - | 0.6 g. |
| 2. Low calcium water | 200 g |

Extensive mixing for 20 minutes until all sodium alginate is completely dissolved.

| | |
|---|---|
| 3. Hosen (ADAMA - contains 125 | 20 g |
| g/l flutriafol) | |
| 4. Ca(NO₃)₂ | 1 g dissolved in 10 ml water |

This final mixture is then subjected to high sheer mixing for 20 minutes, prior to application to the plants.

### Example 7

### Comparative Study of Prevention of Powdery Mildew (Leveillula Taurica) in Sweet Pepper Plants Using Drip Irrigation

Aim of Study:

The aim of the present study was to compare the effect of an emulsion containing a mixture of hydrophilic and hydrophobic activating agents, as defined in Example 1 of the co-owned international patent application which published as WO 2018/051344A1 (which is incorporated herein by reference, in its entirety), on the health of sweet pepper plants in a field trial. This mixture of agent contains sclareol, naringin, nootkatone, steviol glycoside and cannabidiol (and is sometimes referred to in this Example as ‘WDS’) and was used at two different dosages combined with Hosen (ADAMA—fungicide containing flutriafol—following the label dosage) formulated in alginate sludge compositions of the present invention, which were administered by drip irrigation,

Methods:

A field of sweet pepper plants in the north of Israel was divided into five different treatment zones. The various treatments, as set out in the results table hereinbelow, were administered at the beginning of the trial period by drip irrigation (using randomly assigned replicates), and the health of the plants in the various treatment zones was assessed, with regard to the symptoms of powdery mildew using the following semi-quantitative visual scale:
1 (=clean) to 10 (=fully infected)

Results:

| | Month | Month | Month | Month | Month | Month |
|---|---|---|---|---|---|---|
| Treatments: | 1 | 2 | 3 | 4 | 5 | 6 |
| 1. Commercial | 2 | 3 | 3 | 5 | 7 | 8 |
| treatment - Hosen | | | | | | |
| include foliar | | | | | | |
| application | | | | | | |
| 2. Commercial | 1 | 1 | 1 | 2 | 2 | 2 |
| treatment + | | | | | | |
| WDS 2 L/D and | | | | | | |
| Hosen GB SR | | | | | | |
| 3. Commercial | 1 | 1 | 1 | 2 | 2 | 2 |
| treatment + WDS | | | | | | |
| 4 L/D and Hosen | | | | | | |
| GB SR | | | | | | |
| 4. WDS 2 L/D and | 1 | 1 | 1 | 2 | 2 | 2 |
| Hosen GB SR | | | | | | |
| 5. WDS 4 L/D and | 1 | 1 | 1 | 2 | 2 | 2 |
| Hosen GB SR | | | | | | |
| 6. Commercial | 1 | 2 | 3 | 4 | 5 | 7 |
| treatment - Hosen | | | | | | |
| include foliar | | | | | | |
| application and | | | | | | |
| WDS | | | | | | |

Notes:
a) L/D = application dosage in liters/dunam (Dunam = 1,000 m²)
b) Treatments 1 and 6 are comparative, prior art treatments (using foliar spray administration only)
c) Treatments 2-5 used compositions of the present invention, administered by drip irrigation only.

These results indicate that drip irrigation treatment using various alginate compositions (WDS-GB SR) of the present invention—i.e. treatments 2-5 in the above table—was much more effective in preventing the development of powdery mildew (Leveillula taurica) in sweet pepper plants, compared to commercial treatment or commercial treatment with WDS without sludge formulation. These two commercial treatment modalities (which included alternate treatment with the commercial fungicides Triadimenol, Tebuconazole and Myclobutanil, applied every 8-10 days) were adminstered by foliar application alone.

### Example 8

### Measurement of the Rate of Release of a Hydrophobic Active Agent from an Alginate Composition of the Present Invention

Method:

The rate of release of the hydrophobic compound sclareol from an alginate formulation of the present invention was modelled using a centrifugal method. Briefly, the activating agent emulsion described in Example 3 above was encapsulated in an alginate-containing composition of the present invention (comprising SATIALGINE S 60 NS alginate cross-linked with calcium nitrate and prepared as described in the Examples hereinabove). The following four variations of the composition (two different concentrations of alginate and two different concentrations of calcium nitrate) were prepared:
0.3% alginate+0.5% calcium nitrate
0.3% alginate+1% calcium nitrate
0.6% alginate+0.5% calcium nitrate
0.6% alginate+1% calcium nitrate

For the purposes of this study, the following three different aqueous dilutions of each of the above compositions were prepared and tested:
1:20 dilution.
1:50 dilution
1:100 dilution

Each of the four different concentration compositions listed above were tested at each of these three dilutions, by means of centrifuging aliquots of each preparation at 3,000 RPM for 10 minutes in a benchtop centrifuge. Immediately after each centrifugation, the concentration of sclareol was measured spectrophotometrically in the supernatant. In addition, the concentration of free sclareol (i.e. unencapsulated sclareol) in the supernatant liquid above a tube of alginate sludge (i.e. in which said sludge had settled under gravity) without centrifugation was measured at each of the dilutions, in order to provide a baseline measurement of sclareol release. In this way, any differences in sclareol concentration between the different preparations following centrifugation will be related to the rate of release of that active agent from the alginate sludge.

Results:

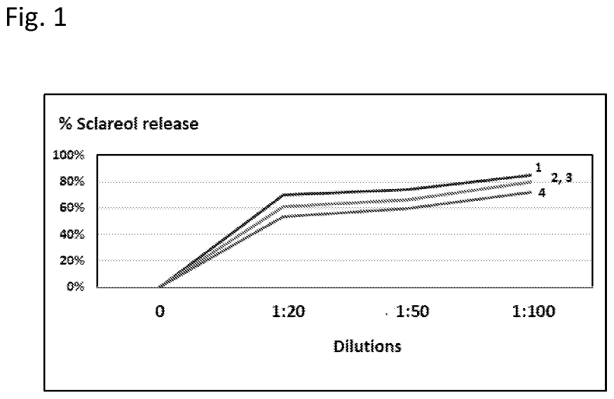

No free sclareol was detectable in the non-centrifuged preparations. However, following the 10-minute centrifugation step, differences in the amount of sclareol present were seen between the different preparations and dilutions. These results are summarized in FIG. 1.

Four different numbered curves are shown FIG. 1, corresponding to the following alginate preparations:
1: 0.3% alginate; 0.5% calcium nitrate
2: 0.6% alginate; 0.5% calcium nitrate
3: 0.3% alginate; 1% calcium nitrate
4: 0.6% alginate; 1% calcium nitrate

(It is be noted that the curves in FIG. 1 corresponding to preparations 2 and 3 are almost overlapping.)

The results shown in FIG. 1 indicate that at each of the three dilutions tested, the preparation containing 0.3% alginate and 0.5% calcium nitrate demonstrated the highest sclareol release (nearly 90% at the 1:100 dilution). Both the 0.6% alginate, 0.5% calcium nitrate and the 0.3% alginate, 1% calcium nitrate preparations had lower release figures (about 80% for each one at the 1:100 dilution). Finally, the preparation shown in curve 4, i.e. 0.6% alginate, 1% calcium nitrate had the lowest release value (about 70% at the 1:100 dilution).

These results show that it is possible to alter the active ingredient release rate from the compositions of the present invention by selecting sludges having different concentrations of alginate and/or calcium ion source. As seen, lower alginate concentrations, and, independently, lower calcium ion concentrations are associated with greater (i.e. faster) release of the actives. Conversely, if it is desired to prepare a composition having a slower release rate, a composition having a higher alginate concentration and/or a higher calcium ion concentration may be chosen. Also, as seen in this figure, preparations having a higher dilution of the sludge are also associated with a faster release rate.

1. A process for the preparation of a slow-release composition suitable for agricultural use, comprising one or more active ingredients selected from the group consisting of fertilizers, pesticides, lipophilic and/or hydrophilic compounds, and mixtures of non-pathogenic bacteria together with lipophilic and/or hydrophilic compounds, said process comprising the steps of:
(a) Preparing a solution of an alkali metal alginate;
(b) Preparing a solution, suspension or emulsion of one or more said active ingredients;
(c) Optionally reducing the particle size of said one or more active ingredients in the solution, suspension or emulsion obtained in step (b), in the presence of a surface-active agent, wherein the final average particle size is 300 pm or less;
(d) Mixing the solution obtained in step (a) with the solution, suspension or emulsion obtained in either step (b) or step (c);
(e) With intensive mixing, add a solution containing calcium ions to the product of step (d), thereby obtaining a sludge comprising said one or more active ingredients encapsulated in alginate particles.

2. The process according to claim 1, wherein the concentration of the alkali metal alginate is in the range of 0.2-1% (w/w).

3. The process according to claim 1, wherein the active ingredient comprises a pesticide.

4. The process according to claim 1, wherein the active ingredient comprises a fertilizer.

5. The process according to claim 1, wherein the active ingredient comprises one or more agrochemical agents.

6. The process according to claim 1, wherein the active ingredient comprises a mixture of lipophilic and/or hydrophilic compounds in the form of an emulsion, said process comprising the steps of:
(a) Preparing a solution of alkali metal alginate;
(b) Particle size reduction of a mixture of said lipophilic and hydrophilic compounds in the presence of a surface-active agent, to a mean particle size below 300 mM;
(c) Combining the solutions of step (a) and step (b);
(d) To the solution obtained from stage (c) add a solution containing Ca²⁺ ions, thereby obtaining an alginate sludge.

7. The process according to claim 1, wherein the active ingredient comprises mixtures of non-pathogenic bacteria together with lipophilic and/or hydrophilic compounds in the form of an emulsion, said process comprising the steps of:
(a) Preparing a solution of alkali metal alginate.
(b) Particle size reduction of a mixture of said lipophilic and hydrophilic compounds in the presence of a surface-active agent, to a mean particle size below 300 mM;
(c) Combining the solutions of step (a) and step (b);
(d) To the product obtained in step (c), add non-pathogenic bacteria, mix together;
(e) With intensive mixing, add a solution containing calcium ions to the product of step (d), thereby obtaining an alginate sludge.

8. The process according to claim 7, wherein the non-pathogenic bacteria are nitrogen-fixing bacteria selected from the group consisting of Rhizobium species and Azospirillum species.

9. The process according to claim 8, wherein the non-pathogenic bacteria are of the species Bacillus subtilis.

10. The process according to claim 1, wherein the alkali metal alginate is sodium or potassium alginate.

11. A composition suitable for agricultural use, comprising one or more active ingredients enveloped by a surfactant and encapsulated in an alginate matrix, wherein said one or more active ingredients are selected from the group consisting of fertilizers, pesticides, lipophilic and/or hydrophilic compounds, and mixtures of non-pathogenic bacteria together with lipophilic and/or hydrophilic compounds, and wherein said composition has a non-dry physical form selected from the group consisting of a sludge, slurry or liquid.

12. The composition according to claim 11, wherein the active ingredient comprises one or more fertilizers.

13. The composition according to claim 11, wherein the fertilizer is urea.

14. The composition according to claim 12, wherein the active ingredient comprises one or more pesticides.

15. The composition according to claim 12, wherein the active ingredients comprise a mixture of lipophilic and/or hydrophilic compounds in the form of an oil in water emulsion.

16. The composition according to claim 15, wherein the lipophilic and/or hydrophilic compounds are compounds with anti-inflammatory activity.

17. The composition according to claim 15, further comprising one or more species of non-pathogenic bacteria.

18. The composition according to claim 17, wherein the non-pathogenic bacterial species are nitrogen-fixing bacteria.

19. The composition according to claim 18, wherein the nitrogen-fixing bacteria are selected from the group consisting of Rhizobium species and Azospirillum species.

20. The composition according to claim 17, wherein the non-pathogenic bacterial species is Bacillus subtilis.

21. A method for the slow-release administration of one or more water-miscible active ingredients to the roots and/or other tissues of growing plants, comprising the steps of:
a) providing a composition comprising said one or more active ingredients enveloped by a surfactant and encapsulated in an alginate matrix, wherein said composition has a non-dry physical form selected from the group consisting of a sludge, slurry or liquid.
b) delivering said composition to said growing plants by depositing said composition in a non-dry form in close proximity to the roots and/or other tissues of said plants,
wherein said one or more active ingredients are selected from the group consisting of fertilizers, pesticides, lipophilic and/or hydrophilic compounds, and mixtures of non-pathogenic bacteria together with lipophilic and/or hydrophilic compounds.

22. The method according to claim 21, wherein depositing said composition in a non-dry form comprise adding said composition to water that is delivered to the plant by means of drip irrigation.

23. The method according to claim 21, wherein depositing said composition in a non-dry form comprises delivering it to the plant by means of direct injection into the roots and/or other tissues of said plant.

24. A method for supplying nitrogen to a plant comprising the steps of:
a) providing a composition comprising a combination of non-pathogenic, atmospheric nitrogen-fixing bacteria and a mixture of one or more lipophilic and hydrophilic activating agents, wherein said bacteria and activating agents are enveloped by a surfactant and encapsulated in an alginate matrix, wherein said composition has a non-dry physical form selected from the group consisting of a sludge, slurry or liquid; and
b) delivering said composition to said growing plants by depositing said composition in a non-dry form in close proximity to the roots and/or other tissues of said plants.

25. The method according to claim 24, wherein the non-pathogenic atmospheric nitrogen-fixing bacteria are members of the Rhizobium genus.

26. The method according to claim 24, wherein the non-pathogenic atmospheric nitrogen-fixing bacteria are members of the Azospirillum genus.

27. A method for increasing the ability of a plant species to resist damage caused by fungal, bacterial and/or viral pathogens, comprising the steps of:
a) providing a composition comprising a combination of non-pathogenic bacteria and a mixture of one or more lipophilic and hydrophilic activating agents, wherein said bacteria and activating agents are enveloped by a surfactant and encapsulated in an alginate matrix, wherein said composition has a non-dry physical form selected from the group consisting of a sludge, slurry or liquid; and
b) delivering said composition to said growing plants by depositing said composition in a non-dry form in close proximity to the roots and/or other tissues of said plants.

28. The method according to claim 27, wherein the non-pathogenic bacteria are of the Bacillus genus.

29. The method according to claim 28, wherein the non-pathogenic bacteria are of the species Bacillus subtilis.

30. The method according to claim 24, wherein the one or more activating agents comprise substances having anti-inflammatory activity.

31. The method according to claim 24, wherein the composition is administered to the plant by adding said composition to water that is delivered to the plant by means of drip irrigation.

32. The method according to claim 24, wherein the composition is administered to the plant by means of direct injection into the roots and/or other tissues of said plant.
